(19) United States
(12) Patent Application Publication
(10) Pub. No.: US 2007/0077438 A1
(43) Pub. Date: Apr. 5, 2007

(54) Soot layer formation for solution doping of glass preforms

(75) Inventors: Robert M. Atkins, Millington, NJ (US); Robert Scott Windeler, Clinton Township, NJ (US)

Correspondence Address: Wendy W. Koba, PO Box 556, Springtown, PA, 18081, US

(73) Assignee: Fitel USA Corp.

(21) Appl. No.: 11/607,385

(22) Filed: Dec. 1, 2006

Related U.S. Application Data
(62) Division of application No. 10/096,020, filed on Mar. 11, 2002.

(51) Int. Cl. B32B 17/06; B32B 9/00

(52) U.S. Cl. 428/428

(57) ABSTRACT

The reproducibility of preforms made by solution doping is significantly improved by adding an internal heat source, such as N₂O, as a processing gas during the soot deposition process. The addition of the internal heat source gas results in forming a surface soot layer which exhibits a relatively uniform and consistent morphology. The improvement in the soot surface morphology results in improving the uniformity of the amount of solution dopant retained in the soot layer from preform to preform.

### TECHNICAL FIELD

The present invention relates to the manufacture of fiber optic preforms useful in forming solution-doped optical fibers and, more particularly, to the utilization of an internal heat source to improve the uniformity of the soot layer morphology, resulting in improving of the uniformity of the dopant concentration added to the soot.

### BACKGROUND OF THE INVENTION

While the variety, forms, and complexity of fiber optic configurations continue to evolve, the central underlying structure found in virtually all optical fibers is a light transmitting core surrounded by a cladding layer. The indices of refraction of the core and cladding are adjusted during manufacture to provide the cladding with an index of refraction that is less than that of the core. When light is pumped into the fiber core, it encounters the refractive index differential at the core/cladding interface and in an optical phenomenon, also referred to as “continuous internal reflection”, is “bent” back with little loss into the core, where it continues to propagate down the optical fiber.

In manufacture, an optical fiber is typically drawn from an optical fiber preform that has essentially the same cross-sectional geometrical arrangement of core and cladding components as that of the final optical fiber, but with a diameter several orders of magnitude greater than that of the fiber. One end of the preform is heated in a furnace to a soft pliable plastic consistency, then drawn lengthwise into a fiber having the desired fiber core/cladding dimension.

In the art of fiber preform manufacture for transmission fibers, techniques have been developed for high speed manufacture using a chemical vapor deposition process, which has been found to be relatively inexpensive, while also providing a high quality fiber. In this process, the necessary cladding and core constituents are supplied in their vapor phase to a horizontally rotated refractory tube to form one or more inner glass layers on the inside surfaces of the tube. Exemplary of this technique is U.S. Pat. No. 4,909,816, issued to MacChesney et al, and its companion patents U.S. Pat. Nos. 4,217,027 and 4,334,903, disclosing what is referred to in the art as the “modified chemical vapor deposition” (MCVD) process.

While the MCVD technique is extremely successful in the manufacture of preforms for transmission fibers, it is not considered as the preferred approach in the manufacture of fibers containing rare earth dopants (e.g., erbium) or other materials (e.g., cobalt) that cannot be successfully deposited on the inner wall of a glass tube using a conventional vapor phase deposition process. In its place, a process referred to as “solution doping” has been developed to form the fiber optic preforms required for these doped fibers. In a conventional solution doping process, a “soot” layer is first formed on the inner wall of a glass tube; the term “soot” is used to define a deposited layer having a large amount of porosity, where the layer is not fully sintered to form a glass (or amorphous) layer. Thereafter, the tube is removed from the processing apparatus and turned “on end” and filled with a solution containing the dopant (such as erbium or cobalt). The soot layer behaves as a “sponge”, absorbing the liquid and, therefore, the dopant. After a predetermined period of time, the liquid is slowly drained from the tube, where the liquid-soaked soot will retain the dopant. The tube is then dried and further processed (oxidized and sintered) to form a glass layer comprising the desired dopant material.

One problem with this prior art solution doping process is that the concentration of the dopant species incorporated during soaking is controlled, to a large extent, by the morphology of the unsintered soot layer. Therefore, it is difficult to reproduce the same dopant concentrations from preform to preform. Reproducibility has now become a very important issue as the preforms fabricated by solution doping have evolved from being drawn into experimental fiber into being used for high tolerance production fiber. Thus, a need remains in the art for a method of improving the reproducibility of the preforms formed using the solution doping process.

### SUMMARY OF THE INVENTION

The need remaining in the prior art is addressed by the present invention, which relates to the manufacture of fiber optic preforms useful in forming solution-doped optical fibers and, more particularly, to the utilization of an internal heat source to improve the uniformity of the soot layer morphology (and, as a result, improve the uniformity of the dopant concentration in the soot).

In accordance with the present invention, an internal gaseous heat source is used in combination with a conventional prior art vapor phase glass precursor used to form the soot, such as SiCl₄ (or GeCl₄, POCl₃, etc.) and oxygen. This may be accomplished using a conventional MCVD process by flowing the gas mixture, including the internal gaseous heat source, into the interior of the tube and heating the tube wall. Preferably, the tube is rotated during this process.

It has been discovered that the addition of the internal gaseous heat source results in forming a dual layer soot; a “bottom” layer and a “top” layer. The bottom soot layer is similar to the soot layer of the prior art, at least in terms of its morphology. As the deposition temperature increases, the thickness and porosity of the bottom layer decreases. Indeed, under certain circumstances the presence of the bottom layer becomes negligible. The addition of an internal gaseous heat source results in forming a “top” layer which exhibits little, if any, change in its morphology as the deposition temperature is varied. Since the dopant added during solution doping will be absorbed by this top layer (which has a much more consistent morphology), the result is a fiber optic preform that exhibits significantly improved reproducibility (from preform to preform) in terms of its dopant concentration.

In accordance with a preferred embodiment of the present invention, N₂O can be used as the internal heat source, and added to the gaseous flow during the soot deposition process. Other gaseous heat sources include, but are not limited to, perchloryl fluoride, silane, chlorosilane, di- or tri-chlorosilane, methane, C₂N₂ (cyanogens), or other gaseous material for providing heat.

Other and further aspects of the present invention will become apparent during the course of the following discussion, and by reference to the accompanying drawings.

### BRIEF DESCRIPTION OF THE DRAWINGS

Referring now to the drawings,

FIGS. 1-3 outline, in general form, the basic steps of a conventional prior art solution doping process;

FIG. 4 is a scanning electron micrograph (SEM) photograph of a dual layer soot structure formed using the internal heat source technique of the present invention;

FIG. 5 is a graph of the internal gas temperature and preform wall temperature, for both a prior art process and the process of the present invention;

FIG. 6 contains a set of SEM photographs showing the top layer morphology for a soot structure of the present invention, as formed at three different deposition temperatures;

FIG. 7 contains a set of SEM photographs showing the morphology of a soot layer formed for the prior art process, for each of the same temperatures as associated with FIG. 6;

FIG. 8 contains cross-sectional SEMs of three dual layer soot structures formed in accordance with the present invention;

FIG. 9 contains a diagram illustrating the relationship between the internal heat source temperature and the gas ignition point within the preform tube;

FIG. 10 is a plot illustrating the concentration of the retained dopant as a function of deposition temperature; and

FIG. 11 contains a plot of solution variability as a function of deposition temperature.

### DETAILED DESCRIPTION

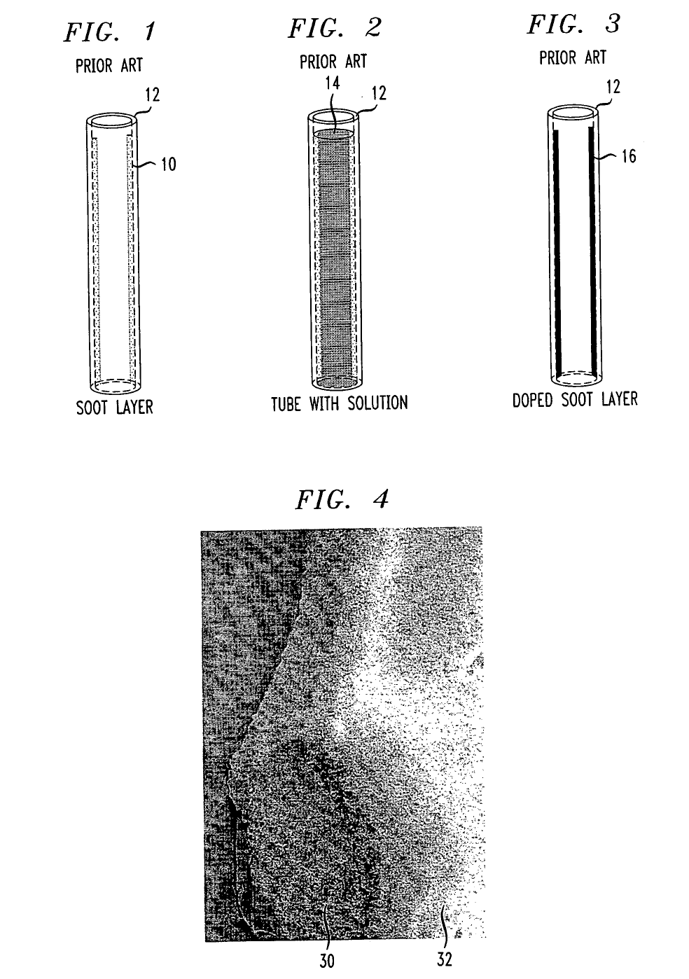

Prior to discussing the improvement in preform reproducibility found from using the process of the present invention, it is useful to have a full understanding of the prior art “solution doping” process of preform construction. In general, solution doping can be broken down into several steps. First, as shown in FIG. 1, an unsintered soot layer 10 is deposited inside a preform tube 12 disposed on a lathe (not shown), where a low temperature process is used to produce a highly porous soot. Second, preform 12 is removed from the lathe and held vertically. A solution 14 containing the desired dissolved dopants (such as, for example, erbium or cobalt) is slowly pumped into preform 12, as shown in FIG. 2, filling the soot pores. The solution typically consists of metal chlorides in a water/alcohol mixture. After a short soaking time, the solution is slowly drained (as shown in FIG. 3). As mentioned above, the soot layer acts as a sponge and retains some of the solution, becoming a doped soot layer 16.

Once solution 14 is drained away, preform 12 is put back on the lathe and doped soot layer 16 is dried by flowing room temperature O₂ through the tube. When doped soot layer 16 is completely dry, the dopants are oxidized and purified by passing oxygen, and then oxygen and chlorine, through preform 12 while heating preform 12 to a temperature greater than 1000° C. Finally, the soot layer is sintered. The entire process can then be repeated if a thicker glass layer is desired.

As mentioned above, the concentration of the species incorporated by the prior art solution doping process is controlled, for the most part, by the morphology of the unsintered soot layer (such as soot layer 10). Indeed, variability in the fiber caused by the solution doping process can be easily understood if the preform soot layer is thought of as a sponge. Assuming a constant dopant molarity in the solution, the amount of dopant incorporated in the soot depends on the ability of the soot to retain the solution. It has been discovered, as will be discussed in detail below, that the addition of an internal heat source, such as N₂O, during the soot deposition process improves the uniformity of the soot. In particular, the addition of the heat source results in forming an additional soot layer (i.e., the “top” layer) which exhibits a consistent morphology as the deposition temperature (and/or other parameters) vary.

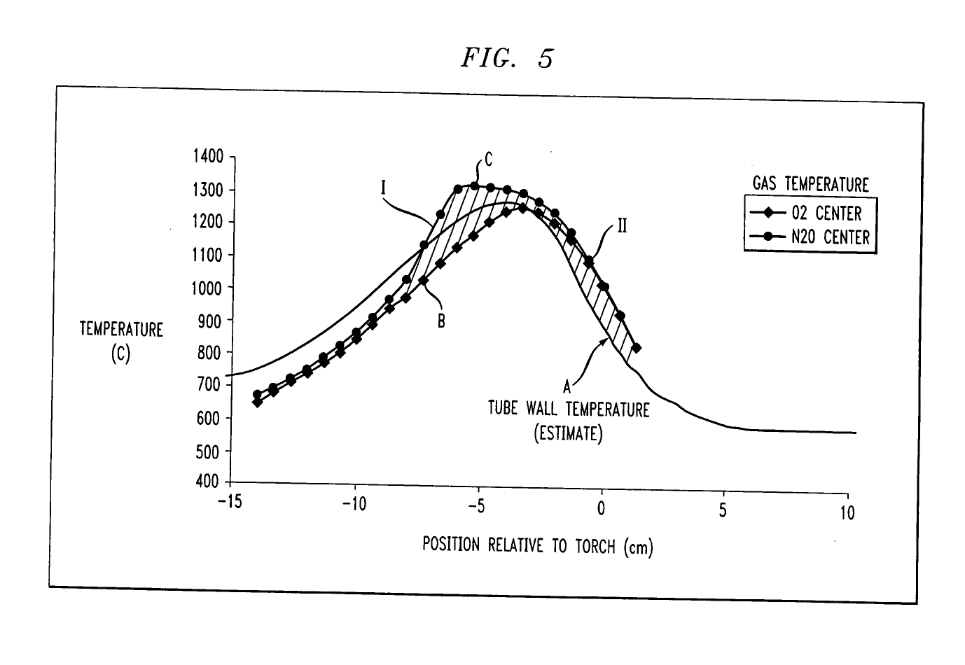

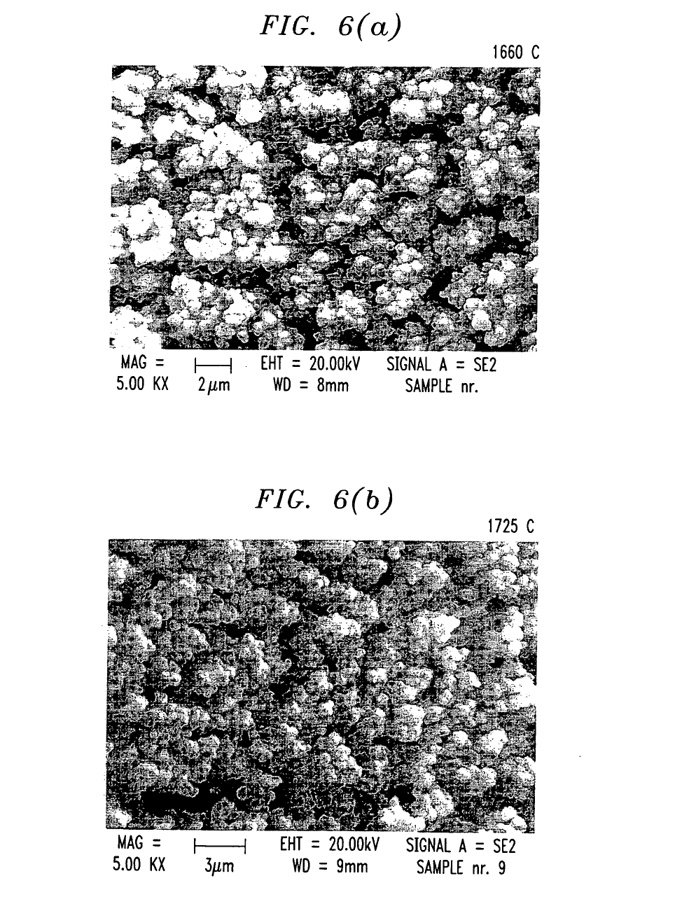

FIG. 4 is an SEM photograph of an actual dual layer soot structure formed using the addition of an internal heat source during soot deposition, in accordance with the present invention. As shown, a bottom soot layer 30 and a top soot layer 32 are formed sequentially during the deposition process, indicating that there are two regions in which thermophoretic deposition takes place. Thermophoretic deposition occurs when the aerosol-containing gas is hotter than the tube wall. The positions of the two deposition regions can be determined by measuring the gas temperature inside the preform tube with and without the additional heat source gas (in this example, N₂O), as shown in FIG. 5. Curve A is a graph of the tube wall temperature, relative to the position of the torch with respect to the longitudinal dimension of the tube. Curve B is associated with the prior art process (i.e., “without N₂O”) and, as shown, contains only a single region where the gas temperature is greater than the tube wall temperature. Curve C is associated with the process of the present invention, and clearly illustrates the presence of two separate regions (labeled I and II in FIG. 5) where the gas temperature in the tube is greater than the temperature of the tube wall. As a result, it has been discovered that this temperature gradient results in the formation of the dual layer soot within the tube. In particular, the N₂O gas produces a flame, which heats the gas upstream of the main torch. This heat produces a deposition layer before the torch, in addition to the standard deposition region downstream of the torch, resulting in the two gas “hot spots” in the tube.

The morphology and thickness of a soot layer can be measured as a function of temperature to aid in determining the benefits of the process of the present invention. The porosity and soot thickness, as shown below, has been found to decrease as temperature increases. However, the porosity and soot thickness decreased significantly less for the process of the present invention when compared to the prior art.

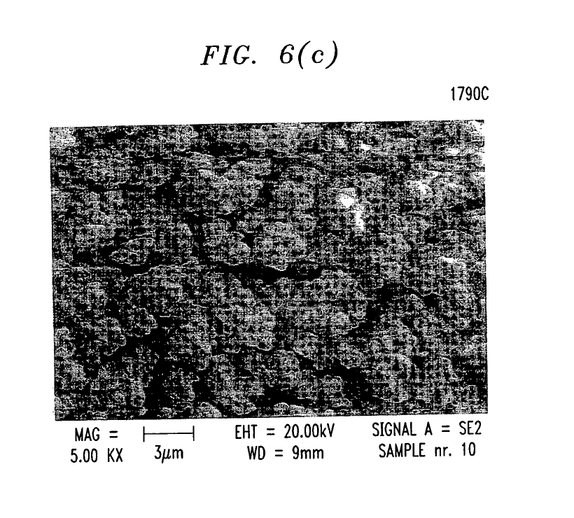

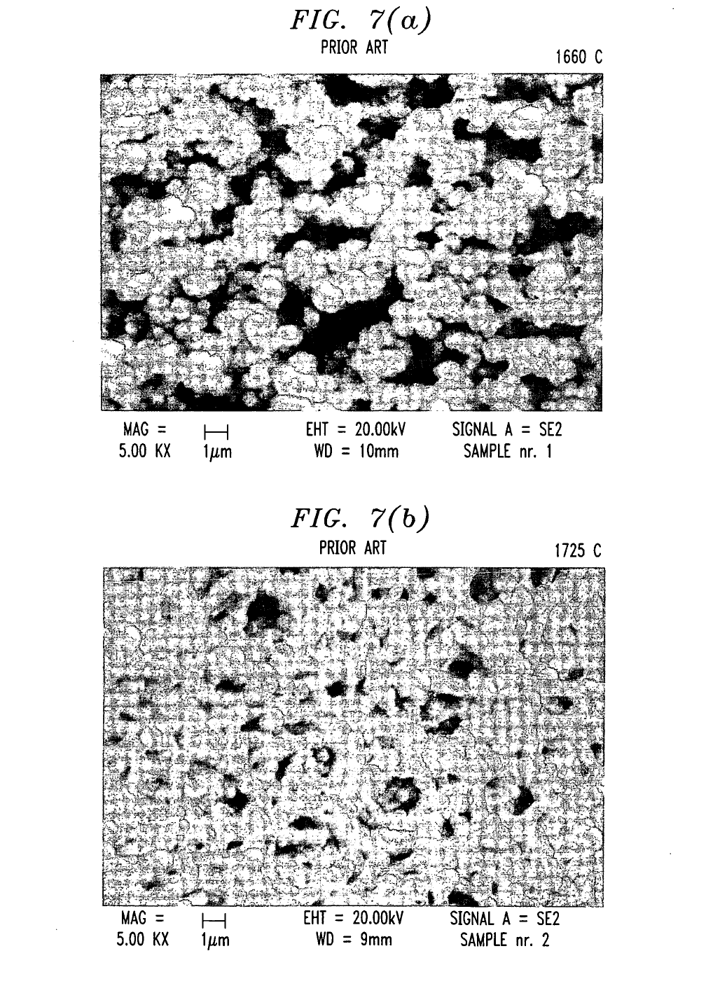

FIG. 6 contains a set of SEM photographs showing the top layer morphology of the additional soot structure formed in accordance with the present invention, that is, using an N₂O internal heat source. In particular, the structure as shown in FIG. 6(a) was formed at a deposition temperature of 1660° C., the structure of FIG. 6(b) at a deposition temperature of 1725° C., and the structure of FIG. 6(c) was formed at a deposition temperature of 1790° C. As shown, for these three deposition temperatures, the top surface of the soot layer exhibits an essentially consistent porosity, independent of temperature. This occurs because the soot is deposited upstream of the torch, where the temperature is low and independent of the torch temperature (hottest point). It is presumed that the bottom soot layer has the same porosity for a given temperature as the prior art soot layer, since it experiences the same temperature profile. For the sake of comparison, FIG. 7 contains a set of SEM photographs showing the top of a soot layer as formed in the prior art for the same three deposition temperatures as used in the formation of the structures illustrated in FIG. 6 (i.e., 1660, 1725 and 1790° C.). Clearly, the porosity of the conventional prior art soot layer, as seen by the differences in surface morphology between FIGS. 7(a), (b) and (c), is a function of the deposition temperature and, as a result, yields unpredictable dopant absorption concentrations.

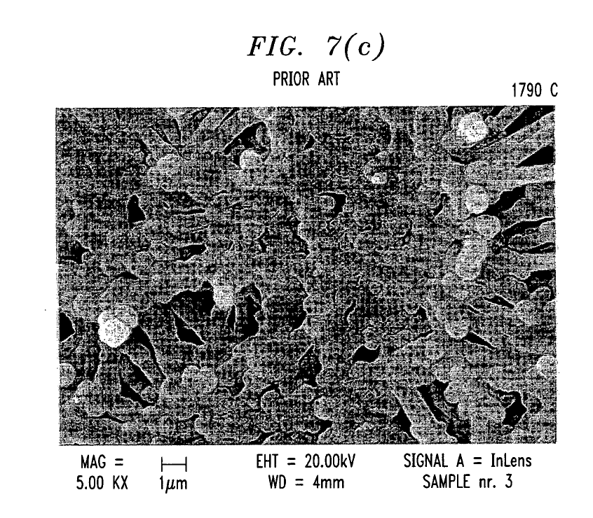

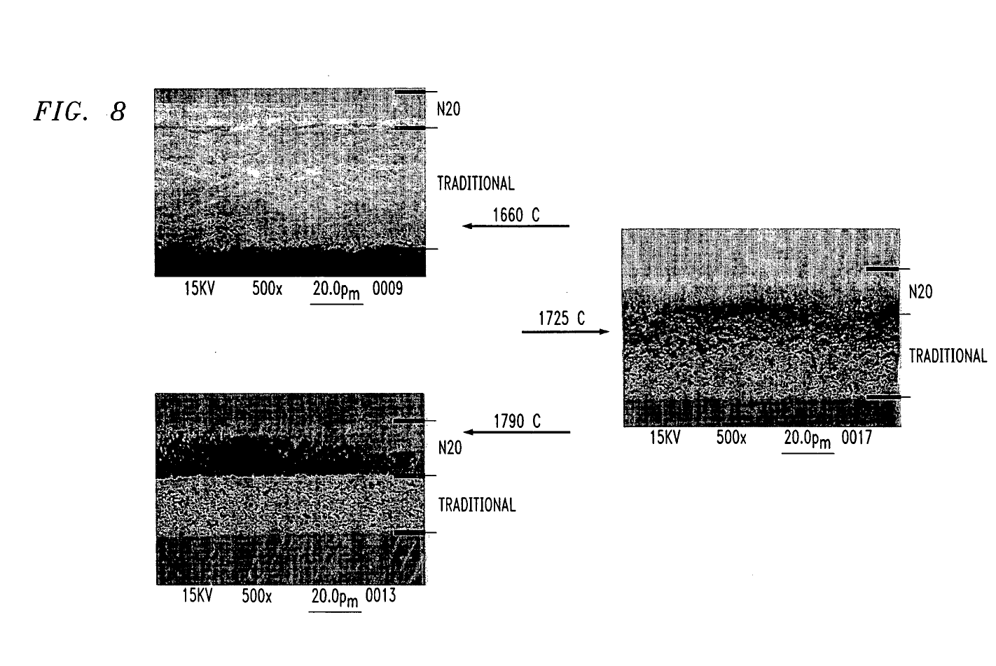

FIG. 8 contains a set of SEM photographs of cross-sectional views of various dual-layer soot structures formed in accordance with the present invention, in particular using an N₂O internal heat source. It can be seen that as the temperature increases, the top layer (i.e., the layer deposited by the N₂O and exhibiting a constant porosity) increases in thickness, while the bottom soot layer becomes thinner. This phenomenon can be explained with reference to FIG. 9. In particular, the N₂O ignites when the tube reaches a critical temperature. The hotter the torch, the farther back in the preform tube this ignition will occur. Referring to FIG. 9, at the lowest ignition temperature (reference point a), the ignition occurs relatively close to the torch position. Raising the ignition temperature to a higher level (indicated at reference point b) moves the ignition further back, as indicated by curve b. A still higher temperature (reference point c), the ignition occurs even further down the tube. As discussed above, as the ignition point moves further back into the tube, a thicker top soot layer will be formed, since this extended ignition point provides a longer time for the soot upstream of the torch to be deposited. The standard (“bottom”) soot layer decreases in thickness with increasing temperature because the porosity decreases and less silica is available (since it was deposited upstream).

In accordance with the present invention and as mentioned above, it is possible to design a solution doping process such that the conventional “bottom” layer is minimized—or even eliminated—by minimizing the temperature gradient between the hottest point created by the external heat source and the downstream tube wall temperature. The minimization of the temperature gradient can be accomplished without affecting the soot deposition rate associated with the internal heat source, since this deposition process is not affected by the downstream tube temperature.

Table I, shown below, illustrates the relationship between the addition of an internal heat source and the soot layer morphology:

As Temperature Increases (Temp ⇑)

| | | Solution Retained | Total Solution |
|---|---|---|---|
| | Thickness | (per micron) | retained |
| Prior Art Soot | ⇓ | ⇓ | ⇓⇓ |
| Deposition Process | | | |
| Inventive Process | ⇓ | ⇓ | ⇓⇓ |
| Bottom Layer | | | |
| Inventive Process Top | ⇑ | No change | ⇑ |
| Layer | | | |

As discussed above, the bottom soot layer deposited using the process of the present invention is similar to the total soot layer deposited when N₂O (or another internal heat source) is not used (i.e., the conventional prior art process). As the temperature increases, the soot thickness and porosity decrease. However, when N₂O is used, an additional high porosity soot layer is deposited, which becomes thicker with increasing temperature. This top soot layer counteracts the negative effects of temperature on the bottom layer. Thus, the improved top soot layer, in terms of more uniform porosity, allows for the dopant concentration retained by each preform to also be more uniform, resulting in improved consistency in the manufacture of preforms.

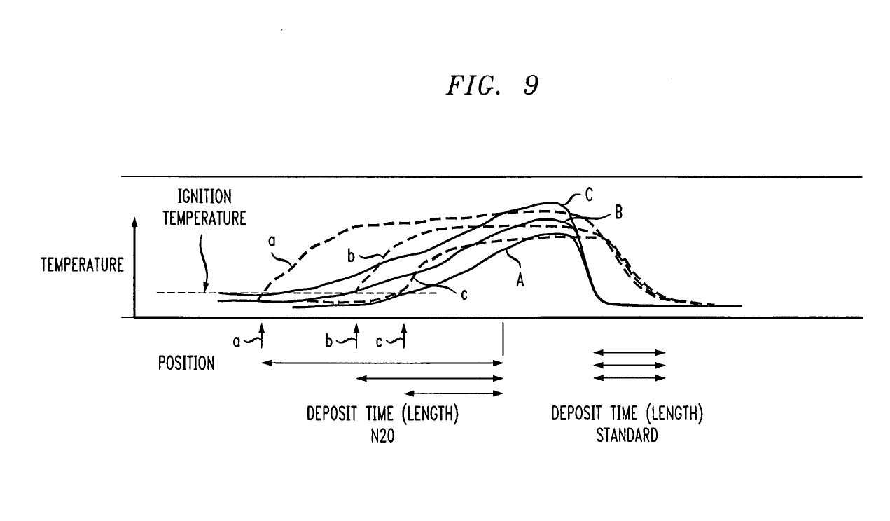

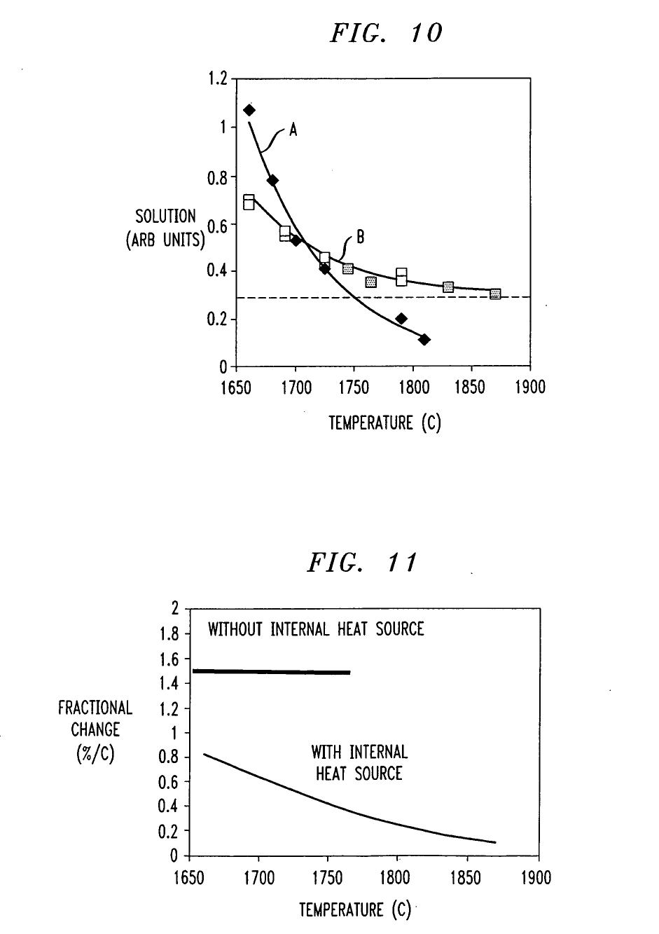

FIG. 10 is a plot illustrating the concentration of dopant (i.e., propanol) retained in the soot layer as a function of deposition temperature. Curve A is associated with the prior art process, and illustrates a strong decrease in retained concentration as a function of temperature. Curve B is associated with the process of the present invention and illustrates a significantly improved result, both in terms of the actual percentage retained, and a relatively small decrease in retention as a function of temperature. FIG. 11 contains a plot of solution variability (i.e., fractional change) in percent as a function of temperature. Fractional change is defined as the change in dopant amount (i.e., rare earth concentration) per change in temperature (T), divided by the total amount of dopant retained for a given amount of silica soot. Expressed as a relation:

$$Fractional change = \frac{[ ⅆ dopant / ⅆ T ]}{dopant}$$

As shown clearly in FIG. 11, this change is significantly reduced as the deposition temperature is increased, improving the uniformity of the dopant concentration in the preform.

It is to be understood that the above-described processes of the present invention are considered to be exemplary only, for the sake of discussion and describing a preferred mode for the process of the present invention. For example, nitrous oxide (N₂O) is to be considered as exemplary only of one possible internal heat source; perchloryl fluoride, silane, chlorosilane, di- or tri-chlorosilane, methane (in general, hydrocarbons), C₂N₂ (cyanogens), and other gaseous material for providing heat are considered to be equally applicable as an internal heat source in the soot structure fabrication process of the present invention. Indeed, the teachings of the present invention are considered to be limited only by the claims which are appended hereto.

1-21. (canceled)

22. An optical preform tube including an internal soot structure used for a solution doping process, said internal soot structure comprising a bottom soot layer disposed adjacent to the optical preform tube and a top soot layer overlying said bottom soot layer said top soot layer, formed by using a heat source internal to said preform tube during deposition so as to form a top soot layer exhibiting an essentially uniform morphology.

23. An optical preform tube as defined in claim 22 wherein the top soot layer is thicker than the bottom soot layer.
